(19) United States
(12) Patent Application Publication
(10) Pub. No.: US 2015/0204711 A1
(43) Pub. Date: Jul. 23, 2015

(54) CALIBRATION DEVICE AND SUBSTRATE TREATMENT DEVICE

(71) Applicant: Ebara Corporation, Tokyo (JP)

(72) Inventor: Mitsunori Sugiyama, Tokyo (JP)

(21) Appl. No.: 14/594,629

(22) Filed: Jan. 12, 2015

(30) Foreign Application Priority Data
Jan. 17, 2014 (JP) 006855/2014

(51) Int. Cl. G01F 25/00; B24B 49/08; B24B 37/34

(52) U.S. Cl. CPC G01F 25/0007; B24B 37/345; B24B 49/08

(57) ABSTRACT

The adjustment section 524 adjusts the correction value by which raw data detected by a measuring instrument provided in a CMP device is corrected to obtain a measured value. The interface section 522 transmits, to the CMP device, a set value used when the correction value is adjusted and an operating instruction based on the set value, and receives a measured value obtained by correcting raw data detected by the measuring instrument based on the correction value while the CMP device operates according to the operating instruction. The adjustment section 524 adjusts the correction value based on the measured value received by the interface section 522 and the set value used when the correction value is adjusted.

### CROSS-REFERENCE TO RELATED APPLICATION

This application is based upon and claims the benefit of priority of the prior Japanese Patent Application No. 2014-006855, filed on Jan. 17, 2014, the entire contents of which are incorporated herein by reference.

### TECHNICAL FIELD

The present invention relates to a calibration device and a substrate treatment device.

### BACKGROUND. ART

Recently, a substrate treatment device has been used for treating a substrate such as a semiconductor wafer in various ways. As one example of the substrate treatment device, a CMP (Chemical Mechanical Polishing) device for polishing a substrate may be given.

The CMP device includes: a polishing unit for polishing a substrate; a washing unit for washing and drying a substrate; a load/unload unit for transferring a substrate to the polishing unit and receiving a substrate washed and dried by the washing unit and the like. Also, the CMP device includes a transporting unit for transporting a substrate in the polishing unit, the washing unit and the load/unload unit. The CMP device carries out various treatments such as polishing, washing and drying in order while the transporting unit transports a substrate.

Well, in at least one of the polishing unit, the washing unit and the load/unload unit, a measuring instrument for measuring various types of data is provided. For example, in the polishing unit, a measuring instrument such as a measuring instrument for measuring a flow rate of a polishing solution used for polishing a substrate is provided. Also, for example, in the washing unit, a measuring instrument such as a measuring instrument for detecting a flow rate of a washing solution supplied to a substrate is provided.

A measuring instrument, in order to apply raw data detected by the measuring instrument to an actual operation of a substrate treatment device, may display or output a measured value obtained by correcting raw data based on a correction value. Here, the correction value may shift due to various factors such as aging degradation of the measuring instrument, and the correction value may be regularly adjusted (calibrated).

In a conventional art, adjustment of the correction value has been carried out by operators who cooperate with each other with the operators being assigned to a control PC, a measuring instrument and an adjustment PC for the correction value in the substrate treatment device, respectively.

For example, in the control PC, a current correction value is set. The operator A assigned to the control PC reads out the current correction value displayed on the control PC and conveys it to the operator B assigned to the adjustment PC. In the adjustment PC, spreadsheet software is installed in which a calculating formula for adjusting the correction value is set. The operator B enters the conveyed current correction value into the spreadsheet software. Also, the operator B reads out a set value (for example, a predetermined, flow rate of a polishing solution) specified by the spreadsheet software and used when the correction value is adjusted from the spreadsheet software, and conveys it to the operator A. The operator A enters the conveyed set value into the control PC, and causes the control PC to output an operating instruction that requires the substrate treatment device to operate according to this set value.

Once the substrate treatment device operates according to the operating instruction, the operator C assigned to the measuring instrument reads out a measured value displayed on the measuring instrument, and conveys it to the operator B. The operator B enters the conveyed measured value into the spreadsheet software. Then, based on the set value used when the correction value is adjusted and the entered measured value and the like, the correction value is adjusted according to the calculating formula set in the spreadsheet software. The operator B reads out the adjusted correction value from the spreadsheet software, and conveys it to the operator A. The operator A enters the conveyed correction value into the control PC to adjust the correction value.
Patent Literature 1: Japanese Patent Laid-Open No. 2011-143537

### SUMMARY OF INVENTION

In the conventional art, efficiently adjusting a correction value for a measuring instrument has not be taken into consideration.

That is, in the conventional art, a plurality of operators (for example, three persons) is necessary to adjust the correction value, therefore it is not efficient. Also, in the conventional art, because a plurality of operators cooperates with each other to adjust the correction value, it takes a comparably long time to adjust it. Furthermore, in the conventional art, a plurality of operators enters a value read out visually into the control PC or the adjustment PC, and appropriate adjustment may not be executed because of a miss such as an input operation miss.

Therefore, it is a problem of the invention of the instant application to efficiently adjust a correction value for a measuring instrument.

One embodiment of a calibration device according to the invention of the instant application has been made with the view to the above problem, and includes: an adjustment section configured to adjust a correction value by which raw data detected by a measuring instrument provided in a substrate treatment device is corrected to obtain a measured value; and an interface section configured to transmit/receive various types of data between the adjustment section and the substrate treatment device, wherein the interface section transmits, to the substrate treatment device, a set value used when the correction value is adjusted and an operating instruction based on the set value, the interface section receives the measured value obtained by correcting raw data detected by the measuring instrument based on the correction value while the substrate treatment device operates according to the operating instruction, and the adjustment section adjusts the correction value based on the measured value received by the interface section and the set value used when the correction value is adjusted.

Also, in one embodiment of a calibration device according to the invention of the instant application, the interface section transmits, to the substrate treatment device, a plurality of set values used when the correction value is adjusted and an operating instruction based on the plurality of set values, the interface section receives the measured value obtained by correcting raw data detected by the measuring instrument based on the correction value every time the substrate treatment device operates according to a plurality of the operating instructions, and the adjustment section can adjust the correction value based on a plurality of the measured values received by the interface section and the plurality of the set values used when the correction value is adjusted.

Also, in one embodiment of a calibration device according to the invention of the instant application, the adjustment section can adjust the correction value based on the measured value received by the interface section, the set value used when the correction value is adjusted and the correction value for correcting the raw data.

Furthermore, in one embodiment of a calibration device according to the invention of the instant application, the interface section can cause a display section to display a current correction value prior to adjustment by the adjustment section, the set value used when the correction value is adjusted, the measured value obtained by correcting the raw data based on the correction value and the correction value adjusted by the adjustment section.

Also, one embodiment of a substrate treatment device according to the invention of the instant application includes: a polishing unit configured to polish a substrate; a washing unit configured to wash and dry the substrate; a load/unload unit configured to transfer the substrate to the polishing unit and receiving the substrate washed and dried by the washing unit; a measuring instrument provided in at least one of the polishing unit, the washing unit and the load/unload unit; and a calibration device for any of the aforementioned.

According to the invention of the instant application, a correction value for a measuring instrument can be efficiently adjusted.

### BRIEF DESCRIPTION OF DRAWINGS

FIG. 1 is a plan view illustrating a general configuration of a substrate treatment device according to a present embodiment;

FIG. 2 is a perspective view schematically illustrating a polishing unit;

FIG. 3A is a plan view illustrating a washing unit;

FIG. 3B is a side view illustrating the washing unit;

FIG. 4 is a view illustrating a configuration of a calibration device and a CMP device;

FIG. 5 is a view illustrating one example of a viewing surface for adjusting a correction value, displayed on a display section via an interface section; and

FIG. 6 is a flowchart illustrating a processing flow of the calibration device.

### DESCRIPTION OF EMBODIMENTS

Now, a calibration device and a substrate treatment device according to one embodiment of the invention of the instant application will be described below with reference to the drawings. A CMP (Chemical Mechanical Polishing) device will be described below as one example of the substrate treatment device, but not limited to this. Also, the substrate treatment device including a load/unload unit 2, a polishing unit 3 and a washing unit 4 will be described below, but not limited to this.

First, a configuration of the CMP device will be described, and subsequently adjustment of a correction value for a measuring instrument will be described.

<Substrate Treatment Device>

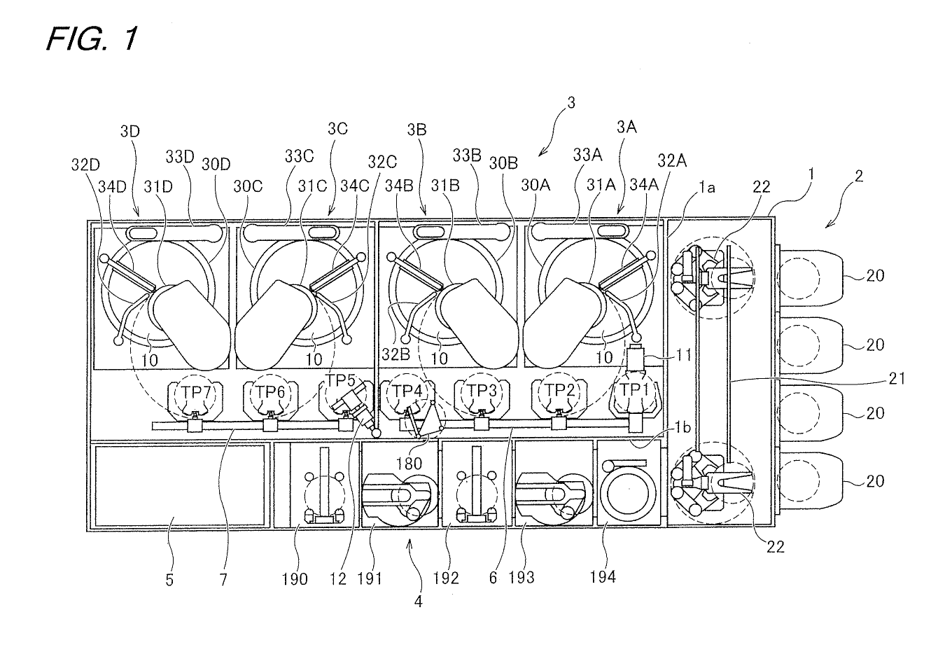

FIG. 1 is a plan view illustrating a general configuration of a substrate treatment device according to one embodiment of the invention of the instant application. As shown in FIG. 1, this CMP device has a roughly rectangular housing 1. The inside of the housing 1 is divided into a load/unload unit 2, a polishing unit 3 and a washing unit 4 by partition walls 1a, 1b. The load/unload unit 2, the polishing unit 3 and the washing unit 4 are independently assembled, respectively, and each of them is provided with independent ventilation. Also, the washing unit 4 has a control device 5 for controlling a substrate treatment operation.

<Load/Unload Unit>

The load/unload unit 2 includes two or more front load sections 20 (in this embodiment, 4) on which a wafer cassette for stocking many wafers (substrate) is mounted. These front load sections 20 are disposed adjacent to the housing 1, and arranged along a width direction of the substrate treatment device (a direction perpendicular to a longitudinal direction). The front load section 20 is capable of mounting an open cassette, an SMIF (Standard Manufacturing Interface) pod or a FOUP (Front Opening Unified Pod). Here, the SMIF and the FOUP are a closed container that contains the wafer cassette therein, and is covered with a partition wall so that its internal environment can be kept independent from the outside.

Also, in the load/unload unit 2, a motion mechanism 21 is laid along a row of the front load sections 20. On the motion mechanism 21, two transportation robots (loader, transportation mechanism) 22 movable along an array direction of the wafer cassette are provided. The transportation robot 22 moves on the motion mechanism 21 so that it can access the wafer cassette mounted on the front load section 20. Each of the transportation robots 22 has two hands, one above the other. The upper hand is used when a wafer already treated is brought back to the wafer cassette. The lower hand is used when a wafer prior to treatment is taken out of the wafer cassette. In such a manner, the upper and lower hand can be used properly. Furthermore, the lower hand of the transportation robot 22 is configured to be rotated around its shaft center so that the wafer can be inverted.

Because the load/unload unit 2 is a region that has to be kept at the cleanest condition, the inside of the load/unload unit 2 is always maintained at a pressure higher than that of any of the outside of the CMP device, the polishing unit 3 and the washing unit 4. The polishing unit 3 is the dirtiest region due to use of slurry as a polishing solution. Therefore, a negative pressure is formed inside the polishing unit 3, and the pressure is kept at a pressure lower than an inner pressure of the washing unit 4. The load/unload unit 2 includes a filter and fan unit (not shown) having a clean air filter such as an HEPA filter, an ULPA filter or a chemical filter. From the filter and fan unit, clean air with particles, toxic vapor and a poisonous gas being removed always comes out.

<Polishing Unit>

The polishing unit 3 provides a region where a wafer is polished (planarized), and includes a first polishing unit 3A, a second polishing unit 3B, a third polishing unit 3C and a fourth polishing unit 3D. The first polishing unit 3A, the second polishing unit 3B, the third polishing unit 3C and the fourth polishing unit 3D, as shown in FIG. 1, are arranged along a longitudinal direction of the substrate treatment device.

As shown in FIG. 1, the first polishing unit 3A includes a polishing table 30A to which a polishing pad 10 having a polishing surface is attached. Also, the first polishing unit 3A includes a top ring 31A for holding a wafer and pressing it onto the polishing pad 10 on the polishing table 30A to allow polishing. Furthermore, the first polishing unit 3A includes a polishing solution supply nozzle 32A for supplying a polishing solution and a dressing solution (for example, deionized water) to the polishing pad 10. Also, the first polishing unit 3A includes a dresser 33A for dressing the polishing surface of the polishing pad 10. Additionally, the first polishing unit 3A includes an atomizer 34A for atomizing a mixed fluid of a liquid (for example, deionized water) and a gas (for example, nitrogen gas), or a liquid (for example, deionized water) to spray it on the polishing surface.

Similarly, the second polishing unit 3B includes a polishing table 30B to which the polishing pad 10 is attached, a top ring 31B, a polishing solution supply nozzle 32B, a dresser 33B and an atomizer 34B. The third polishing unit 3C includes a polishing table 30C to which the polishing pad 10 is attached, a top ring 31C, a polishing solution supply nozzle 32C, a dresser 33C and an atomizer 34C. The fourth polishing unit 3D includes a polishing table 30D to which the polishing pad 10 is attached, a top ring 31D, a polishing solution supply nozzle 32D, a dresser 33D and an atomizer 34D.

Because the first polishing unit 3A, the second polishing unit 3B, the third polishing unit 3C and the fourth polishing unit 3D have an identical configuration with each other, the first polishing unit 3A will be described below.

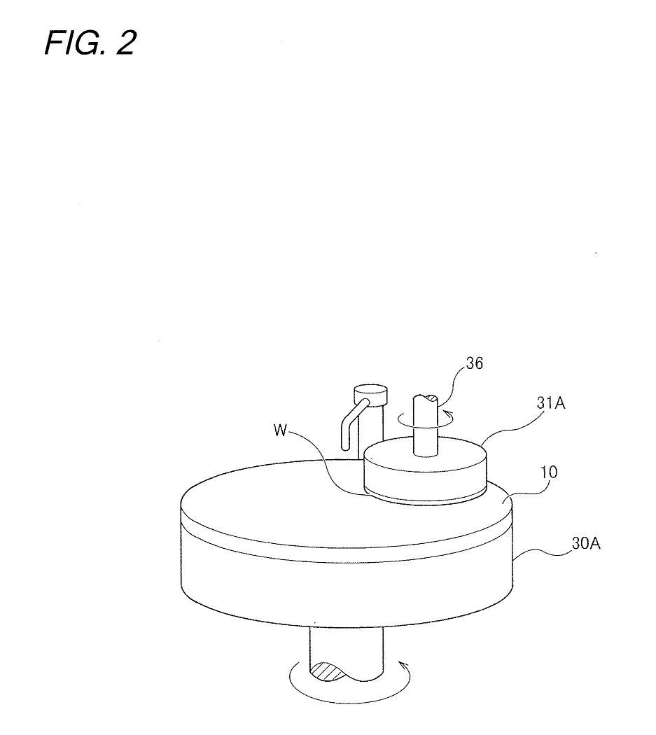

FIG. 2 is a perspective view schematically illustrating the first polishing unit 3A. The top ring 31A is supported by a top ring shaft 36. On the upper surface of the polishing table 30A, the polishing pad 10 is applied, and the upper surface of the polishing pad 10 forms a polishing surface for polishing a wafer W. Note that a fixed, abrasive coating can be used instead of the polishing pad 10. The top ring 31A and the polishing table 30A are configured to rotate around the shaft center as shown by the arrow. The wafer W is supported on the lower surface of the top ring 31A by means of vacuum suction. On polishing, a polishing solution is supplied to the polishing surface of the polishing pad 10 from the polishing solution supply nozzle 32A, and the wafer W to be polished is pressed onto the polishing surface by means of the top ring 31A to be polished.

Next, the transportation mechanism for transporting a wafer will be described. As shown in FIG. 1, adjacent to the first polishing unit 3A and the second polishing unit 3B, a first linear transporter 6 is disposed. The first linear transporter 6 is a mechanism for transporting a wafer among four transportation positions along a direction in which the polishing units 3A, 3B are arranged (assuming that a first transportation position TP1, a second transportation position TP2, a third transportation position TP3 and a fourth transportation position TP4 are arranged in order from the load/unload unit).

Also, adjacent to the third polishing unit 3C and the fourth polishing unit 3D, a second linear transporter 7 is disposed. The second linear transporter 7 is a mechanism for transporting a wafer among three transportation positions along a direction in which the polishing units 3C, 3D are arranged (assuming that a fifth transportation position TP5, a sixth transportation position TP6 and a seventh transportation position TP7 are arranged in order from the load/unload unit).

A wafer is transported to the polishing units 3A, 3B by the first linear transporter 6. The top ring 31A of the first polishing unit 3A is moved between a polishing position and the second transportation position TP2 by means of a swing movement of a top ring head. Thus, a wafer is transferred to the top ring 31A at the second transportation position TP2. Similarly, a top ring 31B of the second polishing unit 3B is moved between the polishing position and the third transportation position TP3, and a wafer is transferred to the top ring 31B at the third transportation position TP3. A top ring 31C of the third polishing unit 3C is moved between the polishing position and the sixth transportation position TP6, and a wafer is transferred to the top ring 31C at the sixth transportation position TP6. A top ring 31D of the fourth polishing unit 3D is moved between the polishing position and the seventh transportation position TP7, and a wafer is transferred to the top ring 31D at the seventh transportation position TP7.

At the first transportation position TP1, a lifter 11 for receiving a wafer from the transportation robot 22 is disposed. The wafer is transferred to the first linear transporter 6 from the transportation robot 22 via the lifter 11. At a position between the lifter 11 and the transportation robot 22, a shutter (not shown) is provided in the partition wall 1a. On transporting a wafer, the shutter is opened and the wafer is transferred to the lifter 11 from the transportation robot 22. Among the first linear transporter 6, the second linear transporter 7 and the washing unit 4, a swing transporter 12 is disposed. The swing transporter 12 has a hand movable between the fourth transportation position TP4 and the fifth transportation position TP5. A wafer is transferred from the first linear transporter 6 to the second linear transporter 7 by the swing transporter 12. A wafer is transported to the third polishing unit 3C and/or the fourth polishing unit 3D by the second linear transporter 7. Also, a wafer polished by the polishing unit 3 is transported to the washing unit 4 via the swing transporter 12.

<Washing Unit>

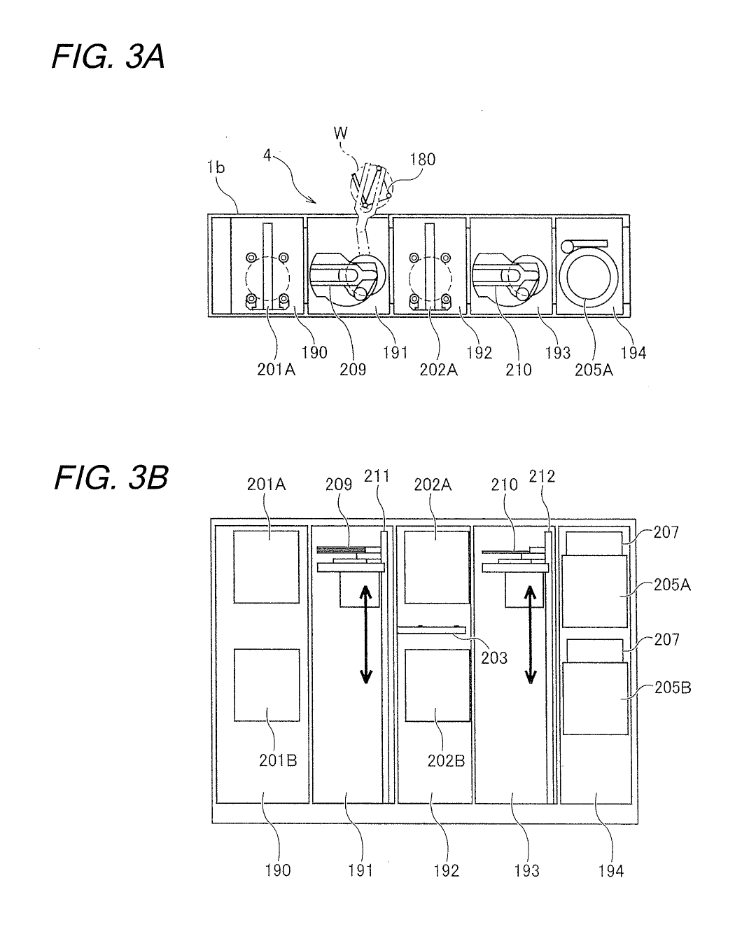

FIG. 3A is a plan view illustrating the washing unit 4. FIG. 3B is a side view illustrating the washing unit 4. As shown in FIG. 3A and FIG. 3B, the washing unit 4 is divided into a first cleaning room 190, a first transportation room 191, a second cleaning room 192, a second transportation room 193 and a drying room 194. In the first cleaning room 190, an upper, primary washing module 201A and a lower, primary washing module 201B arranged along a longitudinal direction are disposed. The upper, primary washing module 201A is disposed above the lower, primary washing module 201B. Similarly, in the second cleaning room 192, an upper, secondary washing module 202A and a lower, secondary washing module 202B arranged along a longitudinal direction are disposed. The upper, secondary washing module 202A is disposed above the lower, secondary washing module 202B. The primary and secondary washing module 201A, 201B, 202A, 202B are a washer for washing a wafer using a washing solution. Because the primary and secondary washing module 201A, 201B, 202A, 202B are arranged along a vertical direction, there is an advantage of a small footprint area.

Between the upper, secondary washing module 202A and the lower, secondary washing module 202B, a temporary stand 203 for a wafer is provided. In the drying room 194, an upper, drying module 205A and a lower, drying module 205B arranged along a vertical direction are disposed. The upper, drying module 205A and the lower, drying module 205B are spaced apart from each other. On top of the upper, drying module 205A and the lower, drying module 205B, filter and fan units 207, 207 for supplying clean air into the drying modules 205A, 205B, respectively, are provided. The upper, primary washing module 201A, the lower, primary washing module 201B, the upper, secondary washing module 202A, the lower, secondary washing module 202B, the temporary stand 203, the upper, drying module 205A and the lower, drying module 205B are fixed on a flame not shown by means of a bolt and the like.

In the first transportation room 191, a first transportation robot (transportation mechanism) 209 movable up and down is disposed. In the second transportation room 193, a second transportation robot 210 movable up and down is disposed. The first transportation robot 209 and the second transportation robot 210 are movably supported by support axes 211, 212 extending in a vertical direction, respectively. The first transportation robot 209 and the second transportation robot 210 have a driving mechanism such as a motor therein, and are movable up and down along the support axis 211, 212, respectively. The first transportation robot 209, similarly to the transportation robot 22, has two hands, one above the other. In the first transportation robot 209, as shown by the dashed line in FIG. 3A, its lower hand is disposed at a position where the lower hand can access the above temporary stand 180. When the lower hand of the first transportation robot 209 accesses the temporary stand 180, a shutter (not shown) provided in the partition wall 1b is opened.

The first transportation robot 209 operates to transport a wafer W among the temporary stand 180, the upper, primary washing module 201A, the lower, primary washing module 201B, the temporary stand 203, the upper, secondary washing module 202A and the lower, secondary washing module 202B. When a wafer prior to washing (the wafer to which slurry adheres) is transported, the first transportation robot 209 uses the lower hand, and when a wafer after washing is transported, the first transportation robot 209 uses the upper hand. The second transportation robot 210 operates to transport the wafer W among the upper, secondary washing module 202A, the lower, secondary washing module 202B, the temporary stand 203, the upper, drying module 205A and the lower, drying module 205B. The second transportation robot 210 transports only the washed wafer, so that it has only one hand. The transportation robot 22 shown in FIG. 1 takes out a wafer from the upper, drying module 205A or the lower, drying module 205B by using its upper hand, and bring the wafer back to the wafer cassette. When the upper hand of the transportation robot 22 accesses the drying module 205A, 205B, a shutter (not shown) provided in the partition wall 1a is opened.

<Adjustment of Correction Value for Measuring Instrument>

Next, adjustment of a correction value for a measuring instrument will be described.

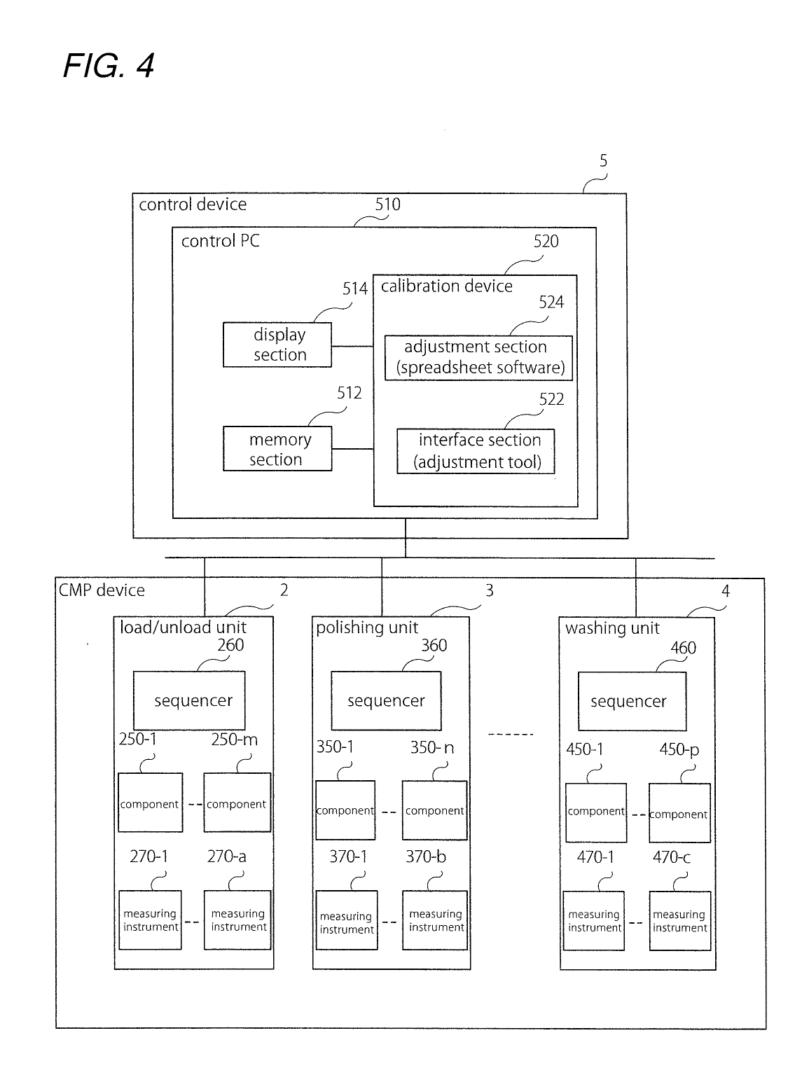

FIG. 4 is a view illustrating a configuration of the calibration device and the CMP device. As described above, the CMP device includes a plurality of units such as the load/unload unit 2, the polishing unit 3 and the washing unit 4.

The load/unload unit 2 includes a sequencer 260 for controlling operation of a plurality of components 250-1 to 250-m (such as the transportation robot 22) in the load/unload unit 2. Also, the load/unload unit 2 includes a plurality of measuring instruments 270-1 to 270-a for detecting data about control of the load/unload unit 2. The measuring instruments 270-1 to 270-a include, for example, a sensor such as a sensor for detecting whether a wafer is placed on the transportation robot 22 or not.

The polishing unit 3 includes a sequencer 360 for controlling operation of a plurality of components 350-1 to 350-n (the polishing table, the top ring and the like) in the polishing unit 3. Also, the polishing unit 3 includes a plurality of measuring instruments 370-1 to 370-b for detecting data about control of the polishing unit 3. The measuring instruments 370-1 to 370-b include, for example, a sensor for detecting a flow rate of a polishing solution supplied to the polishing pad 10, a sensor for detecting the number of revolutions of the polishing table 30, a sensor for detecting a rotary torque of the polishing table 30 or the top ring 31, and the like.

The washing unit 4 includes a sequencer 460 for controlling operation of a plurality of components 450-1 to 450-p (the washing module, the transportation robot, or the like) in the washing unit 4. Also, the washing unit 4 includes a plurality of measuring instruments 470-1 to 470-c for detecting data about control of the washing unit 4. The measuring instruments 470-1 to 470-c include, for example, a sensor such as a sensor for detecting a flow rate of a washing solution supplied to a wafer.

The control device 5 is connected to the load/unload unit 2 (sequencer 260), the polishing unit 3 (sequencer 360) and the washing unit 4 (sequencer 460). The control device 5 includes a control PC 510.

The control PC 510 includes a memory section 512, a display section 514 and a calibration device 520. The calibration device 520 includes an interface section (adjustment tool) 522 and an adjustment section (spreadsheet software) 524.

The memory section 512 is a storage medium capable of storing various types of data. The memory section 512 stores, for example, a correction value by which raw data detected by a measuring instrument provided in the CMP device is corrected to obtain a measured value. Also, the memory section 512 stores, for example, a set value (for example, a flow rate of a polishing solution) used when the correction value is adjusted.

The display section 514 is an output interface for displaying various types of data. The display section 514 displays, for example, a current correction value, a set value list for adjustment of a correction value, a measured value measured by a measuring instrument (a value obtained by correcting raw data based on the correction value), an adjusted correction value and the like. Furthermore, the display section 514 can also display a calculating formula for adjustment of the correction value (the calculating formula set in the adjustment section 524) and the like.

The interface section 522 provides an interface for transmitting/receiving various types of data between the adjustment section 524 and the CMP device. In particular, the interface section 522 transmits, to the CMP device, a set value used when the correction value is adjusted (for example, a flow rate of a polishing solution) and an operation instruction based on the set value. Also, the interface section 522 receives a measured value obtained by correcting raw data detected by a measuring instrument (for example, a flow rate sensor provided in the polishing unit 3) based on the correction value while the CMP device operates according to the operating instruction.

The adjustment section 524 adjusts a correction value by which raw data detected by a measuring instrument provided in the CMP device is corrected to obtain a measured value. In particular, the adjustment section 524 adjusts the correction value based on the measured value received by the interface section 522 (for example, a measured value by a flow rate sensor provided in the polishing unit 3) and the set value used when the correction value is adjusted (for example, a flow rate of a polishing solution). The adjustment section 524 may be, for example, a spreadsheet software in which a calculating formula for adjusting a correction value is set, but not limited to this. Note that if the adjustment section 524 is formed by the spreadsheet software, then a plurality of tabs may be provided in the spreadsheet software so that a particular tab can be displayed/hidden. Also, if adjustment of a correction value extends over two or more tabs in a spreadsheet software, then the adjustment can be carried out while the tabs are automatically switched. Also, the calculating formula for adjustment of the correction value can be optionally changed by editing the spreadsheet software. The set value used when the correction value is adjusted can be optionally changed by editing the spreadsheet software. Furthermore, when the spreadsheet software is edited, an item to be edited is highlighted so that convenience can be improved. Additionally, if adjustment is carried out for a plurality of different, measuring instruments, then the spreadsheet software can be switched for each measuring instrument.

Note that there may be the situation where it is difficult to precisely adjust a correction value by one operation of the CMP device based on one set value. For example, let's consider the situation where a measured value of some measuring instrument is obtained by multiplying raw data detected by the measuring instrument and a correction value a and adding a correction value b to the resultant value. In such a situation, in order to adjust both of the correction values a, b, it becomes necessary to operate the CMP device based on at least two different, set values.

In such a situation, the interface section 522 transmits, to the CMP device, a plurality of set values used when the correction value is adjusted and an operating instruction based on the plurality of set values. Also, the interface section 522 receives a measured value obtained by correcting raw data detected by a measuring instrument based on the correction value every time the CMP device operates according to a plurality of the operating instructions.

Then, the adjustment section 524 adjusts the correction value based on a plurality of the measured values received by the interface section 522 and the plurality of set values used when the correction value is adjusted.

Additionally, the adjustment section 524 can also adjust the correction value based on the measured value received by the interface section 522, the set value used when the correction value is adjusted and the correction value for correcting raw data (a current correction value).

Also, the interface section 522 is also an interface that transmits, to the display section 514, the current correction value prior to adjustment by the adjustment section 524, the set value used when the correction value is adjusted, the measured value obtained by correcting raw data based on the correction value and the correction value adjusted by the adjustment section 524 to cause the display section 514 to display them, and also receives information input via the display section 514 and the like.

<One Example of Viewing Surface for Adjustment of Correction Value>

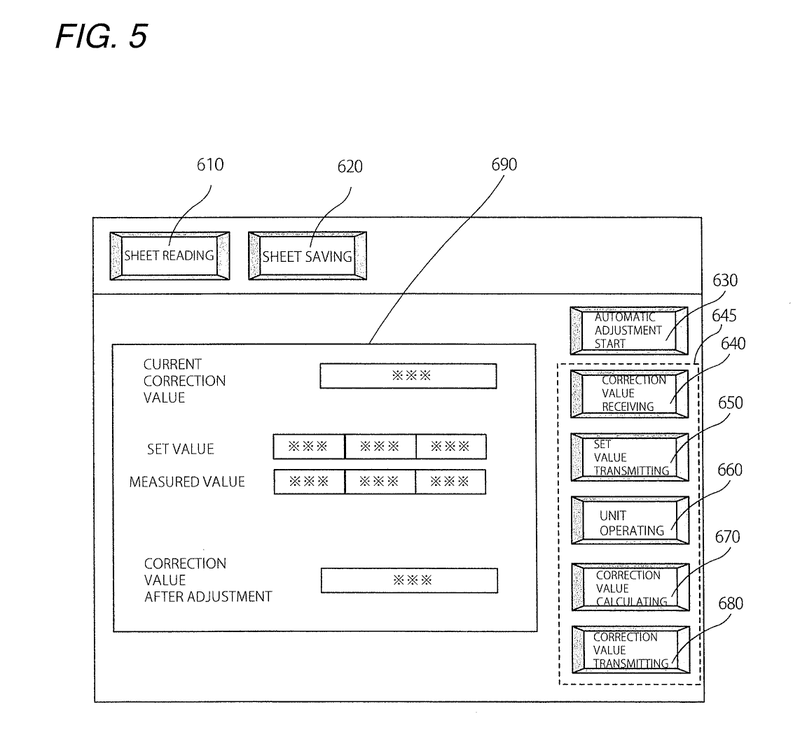

FIG. 5 is a view illustrating one example of a viewing surface for adjustment of the correction value, displayed on the display section via the interface section.

As shown in FIG. 5, the display section 514 displays a sheet reading button 610, a sheet saving button 620, an automatic adjustment start button 630, a correction value receiving button 640, a set value transmitting button 650, a unit operating button 660, a correction value calculating button 670, a correction value transmitting button 680 and a control sheet 690.

The sheet reading button 610 is a button for reading in the control sheet 690 when the correction value is adjusted. The sheet saving button 620 is a button for saving the control sheet 690 in the memory section 512 after the correction value is adjusted.

The automatic adjustment start button 630 is a button for automatically carrying out a series of treatments for adjustment of the correction value. The correction value receiving button 640, the set value transmitting button 650, the unit operating button 660, the correction value calculating button 670 and the correction value transmitting button 680 are included in a button group 645 for manual adjustment of the correction value.

The correction value receiving button 640 is a button for obtaining the current correction value. The set value transmitting button 650 is a button for transmitting, to the CMP device, the set value for adjustment of the correction value (for example, a flow rate of a polishing solution). The unit operating button 660 is a button for operating the CMP device or any unit in the CMP device based on the set value. The correction value calculating button 670 is a button for adjusting the correction value. The correction value transmitting button 680 is a button for transmitting the adjusted correction value to the CMP device or the measuring instrument provided in the CMP device.

The control sheet 690 includes the current correction value prior to adjustment by the adjustment section 524. Also, the control sheet 690 includes a plurality of set values for adjustment of the correction value and a plurality of correction values resulting from correcting raw data detected by the measuring instrument using the correction value. Furthermore, the control sheet 690 includes the correction value after adjustment by the adjustment section 524.

Note that the viewing surface displayed on the display section via the interface section may include, in addition to that shown in FIG. 5, for example, a viewing surface for setting the number of times for collecting a measured value (loop count). Also, there may be, for example, the situation that it takes a constant time until the measured value transmitted from the measuring instrument becomes stable, and the viewing surface displayed on the display section via the interface section can include a viewing surface for setting a time for waiting for a start of collecting the measured value. Also, the viewing surface displayed on the display section via the interface section can include, for example, a viewing surface for setting a time during which the measured value is obtained from the measuring instrument (time-out period). Furthermore, the viewing surface displayed on the display section via the interface section can include a viewing surface for setting a sampling time that provides a reference based on which whether the measured value transmitted from the measuring instrument is stable or not is determined.

<Flowchart for Calibration Device>

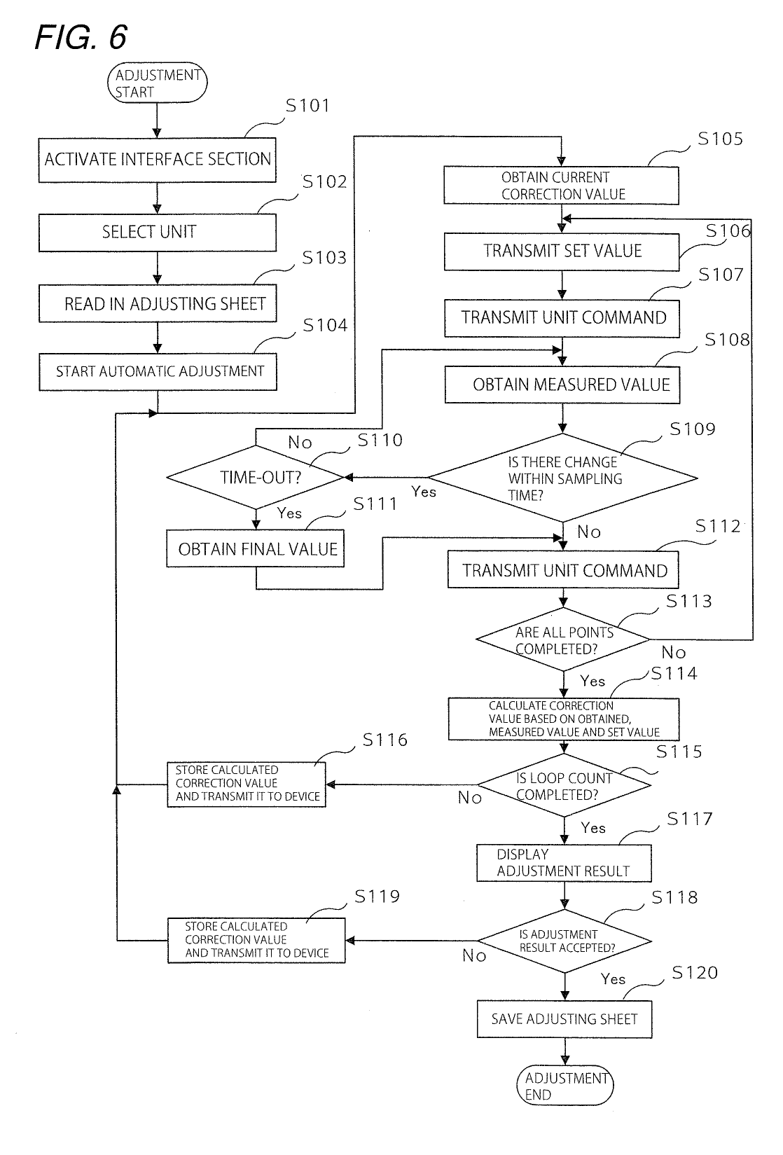

Next, a treatment flow of the calibration device will be described. FIG. 6 is a flowchart illustrating a treatment flow of the calibration device.

First, to start adjustment of the correction value, the interface section (adjustment tool) 522 is activated (step S101). Activation of the interface section 522, for example, can be carried out via various types of input interfaces, such as by a click on a button for activating the adjustment tool displayed on the display section 514.

Next, a unit whose correction value is to be adjusted is selected (step S102). Selection of the unit, for example, can be carried out via various types of input interfaces, such as by a click on a button for selection of unit displayed on the display section 514. Note that correspondingly to a kind of the unit whose correction value is to be adjusted, the viewing surface on the display section 514 may be changed in color. Hereby, which unit has the correction value of the measuring instrument thereof being adjusted can be made more clearly visible.

Subsequently, the control sheet is read in (step S103). The control sheet can be read in, for example, by a click on the sheet reading button 610 on the viewing surface after activation of the adjustment tool shown in FIG. 5.

Next, automatic adjustment is started (step S104). The automatic adjustment can be started, for example, by a click on the automatic adjustment start button 630 on the viewing surface after activation of the adjustment tool shown in FIG. 5. Once the automatic adjustment start button 630 is clicked on, the following treatments are automatically carried out, but the automatic adjustment can be also stopped on the way.

Once the automatic adjustment is started, the interface section 522 obtains the current correction value from the memory section 512 (step S105). Subsequently, the interface section 522 obtains the set value used when the correction value is adjusted (for example, 50 mL/sec at a flow rate at which a polishing solution is made to flow) from the memory section 512 and transmits it to the CMP device (step S106).

Next, the interface section 522 transmits a unit command to the CMP device (step S107). Here, the unit command is an operating instruction that requires a component to carry out adjustment of the correction value. For example, on adjusting the correction value for the measuring instrument that measures a flow rate of a polishing solution, a command “open a valve” is transmitted so that the polishing solution is made to actually flow.

Subsequently, the interface section 522 obtains (receives) the measured value from the measuring instrument (step S108). Here, the measured value is the resultant value obtained by correcting raw data detected by the measuring instrument based on the current correction value.

Here, there may be the situation that the measured value obtained from the measuring instrument changes with time. Then, the interface section 522 determines whether the obtained, measured value changes within the sampling time or not (step S109). The interface section 522 determines that the measured value changes within the sampling time when a change in the measured value within the sampling time of, for example, 1 sec is greater than a predetermined threshold value. On the one hand, the interface section 522 determines that the measured value does not change within the sampling time when a change in the measured value within the sampling time of, for example, 1 sec is not greater than the predetermined threshold value.

When the interface section 522 determines that the obtained, measured value changes within the sampling time (step S109, Yes), it determines whether the time-out occurs or not (step S110). Here, whether the time-out occurs or not is determined based on whether from the time when the measured value is first obtained, a preset time-out time elapsed or not.

When the interface section 522 determines that the time-out does not occur (step S110, No), returning to step S108, the measured value is obtained repetitively.

On the one hand, when the interface section 522 determines that the time-out occurs (step S110, Yes), the last measured value is obtained (step S111).

The interface section 522 transmits a unit command to the CMP device (step S112) after step S111 or when it determines that the obtained, measured value does not change within the sampling time (step S109, No). Here, the unit command is an operating instruction that requires a component to stop its operation for adjustment of the correction value. For example, when the correction value for the measuring instrument that measures a flow rate of a polishing solution is adjusted, a command “close a valve” is transmitted that terminates operation to make the polishing solution to flow.

Next, the interface section 522 determines whether adjustment of all points are completed or not (step S113). For example, the interface section 522 determines whether measured values for all a plurality of set values for adjustment of the correction value are obtained or not when there are the plurality of set values (for example, there are three kinds of set values, such as a flow rate of 50 mL/sec, 100 mL/sec, 200 mL/sec and the like at which the polishing solution is made to flow).

The interface section 522, returning to step S106, repeats step S106 to step S112 for a set value not yet executed when it determines that all points are not adjusted (step S113, No).

On the one hand, the adjustment section 524 calculates the correction value based on one or more obtained, measured values and one or more set values used when the correction value is adjusted (step S114) when it is determined that all points are adjusted (step S113, Yes). For example, in the spreadsheet software for the adjustment section 524, the calculating formula for adjustment of the correction value is preset. The adjustment section 524 calculates the adjusted correction value by inputting the obtained, measured value and the set value to the spreadsheet software. Also, the adjustment section 524 may also calculate the adjusted correction value based on the obtained, measured value, the set value used when the correction value is adjusted and the correction value for correcting raw data (current correction value).

Subsequently, the interface section 522 determines whether a loop count is completed or not (step S115). Here, the loop count is a presettable value for improving adjustment accuracy of the correction value.

The interface section 522 stores the calculated correction value in the memory section 512, transmits it to the CMP device (step S116) and returns to step S105 when it determines that the loop count is not completed (step S115, No). That is, the interface section 522, after adopting the calculated correction value, may execute step S105 to S114 again to adjust more than once so that adjustment accuracy of the correction value can be improved.

On the one hand, the interface section 522, in order that the adjustment result of the correction value is confirmed, causes the display section 514 to display the sheet 690 for adjustment as shown in FIG. 5 (step S117) when it determines that the loop count is completed (step S115, Yes).

Next, the interface section 522 determines whether the adjustment result of the correction value is accepted or not (step S118). The adjustment result of the correction value is accepted, for example, via various types of input interfaces, such as by a click on an acceptance button displayed on the display section 514.

The interface section 522 stores the calculated correction value in the memory section 512, transmits it to the CMP device (step S119) and returns to step S105 when it determines that the adjustment result of the correction value is not accepted (step S118, No). That is, the interface section 522, after adopting the calculated correction value, executes step S105 to step S114 again so that it retries adjustment of the correction value.

The interface section 522 saves the control sheet 690 in the memory section 512 (step S120) when it determines that the adjustment result of the correction value is accepted (step S118, Yes). Saving the control sheet 690 allows the adjusted correction value to be transmitted to the CMP device (the measuring instrument), so that the adjusted correction value can be applied to the measuring instrument. Furthermore, the saved control sheet 690 can be a default value at the next adjustment.

As described above, according to this embodiment, a correction value for a measuring instrument can be efficiently adjusted. That is, in the conventional art, a plurality of operators (for example, three persons) is necessary to adjust the correction value, therefore it is not efficient. Also, in the conventional art, because a plurality of operators cooperates with each other to adjust the correction value, it takes a comparably long time to adjust it. Furthermore, in the conventional art, a plurality of operators enters a value read out visually into the control PC or the adjustment PC, and appropriate adjustment may not be executed because of a miss such as an input operation miss.

In contrast, in this embodiment, the interface section 522 is provided, and because the interface section 522 transmits/receives various types of data (for example, the set value used when the correction value is adjusted, the measured value and the like) between the CMP device and the adjustment section 524, a series of treatments for adjustment of the correction value can be automatically executed.

Note that the above embodiment has been described in the situation where adjustment of the correction value is automatically executed, but not limited to this. For example, an operator clicks on the correction value receiving button 640, the set value transmitting button 650, the unit operating button 660, the correction value calculating button 670 and the correction value transmitting button 680 shown in FIG. 5 sequentially so that manual adjustment of the correction value can be also carried out.

### REFERENCE SIGNS LIST

510 control PC
512 memory section
514 display section
520 calibration device
522 interface section
524 adjustment section
610 sheet reading button
620 sheet saving button
630 automatic adjustment start button
640 correction value receiving button
645 button group for manual adjustment
650 set value transmitting button
660 unit operating button
670 correction value calculating button
680 correction value transmitting button
690 control sheet

What is claimed is:

1. A calibration device comprising:
an adjustment section configured to adjust a correction value by which raw data detected by a measuring instrument provided in a substrate treatment device is corrected to obtain a measured value; and
an interface section configured to transmit/receive various types of data between said adjustment section and said substrate treatment device, wherein:
said interface section transmits, to said substrate treatment device, a set value used when said correction value is adjusted and an operating instruction based on said set value,
said interface section receives the measured value obtained by correcting raw data detected by said measuring instrument based on said correction value while said substrate treatment device operates according to said operating instruction, and
said adjustment section adjusts said correction value based on the measured value received by said interface section and the set value used when said correction value is adjusted.

2. The calibration device according to claim 1, wherein:
said interface section transmits, to said substrate treatment device, a plurality of the set values used when said correction value is adjusted and an operating instruction based on said plurality of the set values,
said interface section receives the measured value obtained by correcting raw data detected by said measuring instrument based on said correction value every time said substrate treatment device operates according to a plurality of said operating instructions, and
said adjustment section adjusts said correction value based on a plurality of the measured values received by said interface section and the plurality of the set values used when said correction value is adjusted.

3. The calibration device according to claim 1, wherein:
said adjustment section adjusts said correction value based on the measured value received by said interface section, the set value used when said correction value is adjusted and the correction value for correcting said raw data.

4. The calibration device according to claim 1, wherein:
said interface section causes a display section to display a current correction value prior to adjustment by said adjustment section, the set value used when said correction value is adjusted, the measured value obtained by correcting said raw data based on said correction value and the correction value adjusted by said adjustment section.

5. A substrate treatment device comprising:
a polishing unit configured to polish a substrate;
a washing unit configured to wash and dry said substrate;
a load/unload unit configured to transfer a substrate to said polishing unit and receive a substrate washed and dried by said washing unit;
a measuring instrument provided in at least one of said polishing unit, said washing unit and said load/unload unit; and
the calibration device according to claim 1.
